(19) United States
(12) Patent Application Publication
(10) Pub. No.: US 2010/0297324 A1
(43) Pub. Date: Nov. 25, 2010

(54) POWDER COMPOSITION OF KOREAN PANAKE USING RICE POWDER

(75) Inventors: Young Jae Kim, Seoul (KR); Young Hyo Jeong, Seoul (KR); Hoon Sang Song, Incheon (KR)

Correspondence Address: LAW OFFICES OF KHALILIAN SIRA, LLC, 9100 PERSIMMON TREE ROAD, POTOMAC, MD, 20854, US

(73) Assignee: CJ CHEILJEDANG CORP, JUNG-GU, SEOUL 100-749 (KR)

(21) Appl. No.: 12/747,082

(22) PCT Filed: Dec. 5, 2008
(86) PCT No.: PCT/KR08/07193

§ 371 Date: Jun. 9, 2010

(30) Foreign Application Priority Data
Dec. 10, 2007 (KR) 10-2007-0127373

(51) Int. Cl. A21D 10/04; B02C 11/00

(52) U.S. Cl. 426/552; 426/555; 241/9

(57) ABSTRACT

The present invention relates to a pancake mix composition prepared by the steps of wet grinding and vacuum drying non-glutinous rice, obtaining rice flour of below 100 mesh in size and mixing with denatured tapioca starch and other additive, which is useful to rice producer and food industry because it can possible to make feel comfortable with pancake to a consumer who suffers from indigestion and absorption impediment of food made from wheat flour and also to promote rice consumption by the production of high value-added products.

### TECHNICAL FIELD

The present invention relates to a pancake mix composition containing rice flour, more specifically, to a pancake mix composition which is prepared by the steps of wet grinding and vacuum drying non-glutinous rice, obtaining rice flour of below 100 mesh in size and mixing with denatured tapioca starch and other additive.

### BACKGROUND ART

Wheat which is native to Afghanistan or Kavkaz, is cultivated in a dry field of the temperate regions. Wheat is one of the oldest crops cultivated from 10 to 15 thousands years ago by mankind. As wheat is sensitive to a high temperature, it is possible to cultivate in the region under the average temperature for the year of 3.8° C. and the average temperature for the summer of 14° C. Since the quality of wheat is closely related to the amount of rainfall, hard wheat is produced in the region of continental climate having low amount of rainfall and not high temperature in the ripening season, and soft and powdered wheat is produced in the region of oceanic climate having a mild climate and high amount of rainfall. In Korea, powdered wheat is generally produced but hard wheat can be produced in the inland provinces as making a good selection of kind of wheat.

Wheat ranges of about 22 kinds all over the world and is largely divided into Triticum aestivum, Triticum monococcum, Triticum dicoccom and Triticum timopheevi. Triticum aestivum is occupied 90% of the cultivated area in the world and is also cultivated in the whole of Korean farm. Triticum durum which is secondly widely cultivated, is cultivated in Central Asia, Africa and North America. Triticum durum is most hard among wheat and is used to make macaroni, pasta et al, and is accounted for 5% of total output of the world. Wheat is consumed as assistant food in the oriental country wheras as main food in the western country, and is the two crops for food together with rice in the world. Wheat holds the second place after corn in the output of crops in the world and is used to make bread, cake, noodle et al. by grinding to flour in Korea.

Gluten protein which is contained in wheat and insoluble protein strongly bonding with starch in an albumen, is an important ingredient having an effect on the quality of product since it gives elasticity to paste and make possible to the fermentation, and endows masticating taste to a product such as bagel.

However, gluten protein can be induced celiac disease (also called as Gee's disease) to some consumer. Symptoms of celiac disease is that feces emit much of offensive ordor and is large in quantity, excess fat is present in feces (steatorrhea), gradually malnutrition is occurred and if severe avitaminosis and underdevelopment are out-broken and if going on megaloblastic anemia similar to malignantanemia is out-broken to an adult and sometimes aspect of iron deficiency anemia is found in a child. A factor of celiac disease is not clearly proved, however is familial in much of case. In the most of celiac disease patient, symptoms are reduced in case of having a meal without gluten which is protein ingredient contained in wheat, barley, malt, rye flour et al. Celiac disease is known to occur in deficiency of enzyme for digesting gluten.

Among products made from wheat, a pancake mix composition is a material mixed in cooking of pancake et al. in order to give a crunch taste, in which commercially available pancake mix composition is generally consisted of 85 to 95% of plain flour and reminder of starch, corn flour et al. However, it is not safe from celiac disease as using wheat flour.

Therefore, there are many efforts in progress to develop a pancake mix composition using various materials in order to solve the above-mentioned problems and to satisfy various demand of consumer. In examination of the previous registered patent in relation to a pancake mix composition, there was “pancake mix composition and method for preparing the same by using potato starch”(Korean Patent No.10-0205762), “method for preparing a leek pancake mix composition” (Korean Patent No. 10-0313761), “a pancake mix composition comprising mulberry leaves and buckwheat”(Korean Patent Application No.10-2001-0009827).

Like this, pancake mix composition which is prepared with rice or other cereal, was partially come out for the prevention of celiac disease. However, in order to embody the quality, wheat flour was mixed or gluten was added and thus celiac disease cannot be prevented. Until now, there is no pancake mix composition that whole quantity of wheat flour is replaced with cereal having no gluten while gluten is not added.

Accordingly, we have selected rice capable of replacing wheat as a main ingredient of a pancake mix composition. Rice has no gluten and is extremely much produced in Korea. In recent year, farmers have difficulty in disposing rice since opening of rice market is accelerated and demand for rice of common consumer is decreased and therefore when a pancake mix composition is prepared with rice, the consumption of rice can be increases as well as risk for celiac disease by the intake of wheat flour can be decreased.

Rice can be divided into glutinous rice and non-glutinous rice in accordance with the difference of starch ingredient. Rice starch consists of amylose and amylopectin, non-glutinous rice contains 20% of amylose and remainder of amylopectin wheras glutinous rice contains above 95% of amylopectin. Amylopectin having a branch structure show the so called stickiness since the branch structure is entangled in hydrating.

In the result of concentrated study to rice, we have found that it is preferred to use non-glutinous rice in preparing a pancake mix composition in order to obtain a similar property to a pancake mix composition comprising wheat flour, and have completed the present invention in which a pancake mix composition comprises non-glutinous rice flour.

### DISCLOSURE OF INVENTION

### Technical Problem

Accordingly, the object of the present invention is to prepare a pancake mix comprising rice flour without gluten protein substituting for commercially available pancake mix comprising wheat flour.

In addition, the another object of the present invention is to find the optimized conditions for preparing a pancake mix comprising rice flour and to apply them to a process for preparing a pancake mix composition of the present invention.

### TECHNICAL SOLUTION

The object of the present invention was achieved in that the optimized grinding method was selected by measuring the starch damage according to the grinding method of rice, and rice flour was prepared by the optimized grinding method, and the obtained rice flour, tapioca starch and additive were mixed to make a pancake mix composition, and quality of the pancake mix composition was confirmed by the sensory test for pancake cooked with the pancake mix composition.

In the present invention, “additive” means a material for food which is additionally supplemented in order to improve and intensify the property of a pancake mix composition, and can be defined as a general term for flavoring-seasoning ingredient, functional ingredient etc.

In the grinding method of rice flour, a dry grinding means a method that rice is ground with mill after drying by a natural drying, a hot-wind drying et al., and a wet grinding means a method that rice is ground with mill after soaking in water for a given period of time.

The present invention is characterized in providing a pancake mix composition containing rice flour as the main ingredients and comprising 75 to 85 wt % of rice flour, 5 to 15 wt % of tapioca starch and 5 to 15 wt % of additive.

Preferably, the additive can be one or combination of two or more selected from the group consisting of the mixed vegetable powder, whole egg powder, corn flour, salt, sugar, baking powder, guar gum or gardenia yellow coloring matter.

The present invention is characterized in providing a method for preparing rice flour comprising the steps of wet grinding rice with zet mill, vacuum drying the grinded rice, and separating the vacuum dried rice flour with mesh to obtain rice flour passing out 100 mesh.

### ADVANTAGEOUS EFFECTS

The present invention relates to the pancake mix composition containing rice flour, which is useful to rice producer and food industry because it can possible to make feel comfortable with pancake to a consumer who suffers from indigestion and absorption impediment of food made from wheat flour and also to promote rice consumption by the production of high value-added products.

### BEST MODE FOR CARRYING OUT THE INVENTION

In the followings, the present invention is more detailed described with reference to examples, however, a range of the present invention can not be restricted by those examples.

In the present invention, it is important to find rice flour capable of replacing wheat flour. Accordingly, in order to remove problems, such as swell and stickiness occurring in general rice flour, we selected non-glutinous rice by which the starch damage can be minimized by the processing method and the size. For this purpose, we performed experiments with three conditions by the grinding type of rice, and determined the starch damage to conclude a method for preparing rice flour for a pancake mix composition.

### EXAMPLE 1

### Determination Of The Starch Damage By The Size Of Rice Flour And Yield By The Grinding Method

100 g of rice flour was shaken at 200 rpm with Screen shaker(100 mesh) for 10 minutes and then the starch damage by the size of rice flour was measured.

The starch damage was measured with a glucose determination kit (Megazyme Co.) and construction of the kit and the measurement method were as followings:

Construction of the kit

1. Enzyme

The kit comprised 2 kinds of enzyme. 1.0 mL of fungal a-amylase was diluted with 20 mL of 100 mM sodium acetate buffer (pH 5.0; containing 5 mM of calcium chloride) and kept in a freezer until use. 1.0 mL of amyloglucosidase also was diluted with 10 mL of 100 mM sodium acetate buffer (pH 5.0; containing 5 mM of calcium chloride) and kept in a freezer until use.

2. Reaction reagent

Reaction reagent of the kit (GOPOD=Glucose Oxidase/Peroxidase) comprised glucose reagent buffer (con.) and glucose determination reagent. 25 mL of glucose reagent buffer (con.) was dissolving into distilled water to prepare 1 L of reaction reagent and then 1 mL of glucose determination reagent was dissolved therein.

3. Standard solution

Glucose standard solution was used as a standard solution.

Measurement method of the starch damage

Measurement method of the starch damage was performed with a known general method.

Rice flour sample was weighed and put into a tube of centrifuge (14 mL) which was pre-balanced at 40° C. for 2 to 5 minutes (100±10 mg). Fungal a-amylase solution was pre-balanced in a small beaker at 40° C. for 5 to 10 minutes. 1 mL of the pre-balanced fungal a-amylase solution was put into each tube and then the tube was intensively mixed in vortex for 5 minutes and stored at 40° C. for exactly 10 minutes (after addition of enzyme). 8 mL of sulfuric acid which was diluted to 0.2% (v/v), was added to complete the reaction and the tube was centrifuged at 3000 rpm for 5 minutes. 0.1 mL of supernatant was transferred to a test tube, and amyloglucosidase solution (0.1 mL,2 U) was added to each tube, and the tube was cultured at 40° C. for 10 minutes. About 4.0 mL of GOPOD reagent was added into the tube containing desired test sample (comprising glucose standard solution tube), and the tube was cultured at 40° C. for 20 minutes, and then each sample was measured at 510 nm of absorbance and the starch damage was measured with the following equation:

The starch damage(%)=E*F/W*8.1

in which E=absorbance of sample, F=150/E of glucose standard solution , W=weight of sample.

The starch damage by the size was shown in Table 1.

TABLE 1
The starch damage by the size

| Size | The starch damage(%) |
|---|---|
| Rice flour passing through 100 mesh | 7.729 |
| Rice flour not passing through 100 mesh | 10.274 |

As shown in Table 1, based on 100 mesh, the starch damage of rice flour passing through 100 mesh was significantly low compared to that of rice flour not passing through 100 mesh. Hereafter, in order to increase yield of rice flour passing through 100 mesh, difference of yield was examined by the grinding methods.

In order to examine yield of rice flour passing through 100 mesh by the difference of roller using in rice grinding, 100 kg of rice was ground with zet mill for 30 minutes (group 1) and 100 kg of rice was ground by compressing and impacting with hammer mill for 30 minutes (group 2). After grinding, the grinded rice was divided with the mesh size and yield by the size was examined. The result was shown in Table 2.

TABLE 2
Yield by the size in accordance with the
grinding method(classified by roller)

| Size | | Zet mill (%) | Hammer mil (%) |
|---|---|---|---|
| Below 60 | mesh | 0.10 | 1.85 |
| 60~100 | mesh | 6.74 | 21.94 |
| 100~150 | mesh | 32.54 | 37.69 |
| 150~200 | mesh | 50.98 | 30.69 |
| 200~250 | mesh | 7.98 | 6.59 |
| over 250 | mesh | 1.66 | 1.24 |

| | | |
|---|---|---|
| Total | 100.00 | 100.00 |

As shown in Table 2, among two types of method widely used in grinding rice, i.e. a grinding method with zet mill and a grinding method with hammer mill, grinding method with zet mill could obtain more rice flour passing through 100 mesh. Based on this, zet mill was used for grinding rice hereafter.

### EXAMPLE 2

### The Starch Damage By Grinding Conditions

In grinding rice, there are two type of method such as dry grinding method which is ground rice in the dry state and wet drying method which is ground rice after soaking into water for about 12 hours. In order to examine influence of the drying method to the starch damage of rice, the starch damage of rice was determined by varying the drying method.

As a result shown in Table 3, the starch damage in the dry grinding method was 14.138 and that of the wet grinding method was 4.429 and therefore it can be concluded that the latter less influences starch damage than the former. In the following, experiment was performed by the wet grinding method.

TABLE 3
The starch damage by the grinding method

| Grinding condition | The starch damage(%) |
|---|---|
| Wet grinding | 4.429 |
| Dry grinding | 14.138 |

### Example 3

### The Starch Damage By The Grinding Method

The starch damage was determined by the grinding method of rice flour after wet grinding based on the result of example 2.

As the drying method, a hot-wind drying method and a vacuum drying method were used. Rice flour was dried at 70° C. with both of hot-wind dryer and vacuum dryer until moisture content is reached to 12%.

As a result shown in Table 4, the starch damage was lower in vacuum drying method than that of hot-wind drying method.

TABLE 4
The starch damage by the drying method

| Drying method | The starch damage(%) |
|---|---|
| Hot-wind drying | 7.382 |
| Vacuum drying | 5.651 |

As putting together with the result of examples 1 to 3, because rice flour have low starch damage, it could be concluded that the suitable rice type for the pancake mix composition was rice flour prepared by wet grinding with zet mill, vacuum drying and passing through 100 mesh.

### EXAMPLE 4

### Preparation Of A Pancake Mix Composition Using The Rice Flour

A pancake mix composition was prepared with rice flour as a main ingredient which was prepared based on the results of examples 1 to 3. 80 wt % of rice flour, 11 wt % of denatured tapioca starch and 9 wt % of additive were mixed together to complete the pancake mix composition. The denatured tapioca starch was used to complement the lacked property of rice flour. The additive was mixture of mixed vegetable powder, whole egg powder, corn powder, salt, sugar, baking powder, guar gum or gardenia yellow coloring matter. The denatured tapioca starch was purchased from the Korea Mazudani Co., and starch powder was purchased from Samyangsa Co. The above two material were gluten-free ingredient produced from cereal containing no gluten.

### EXAMPLE 5

### Test Production For Pancake With The Pancake Mix Composition And The Sensory Test Therefor

Test production for pancake was performed with the pancake mix composition according to example 4.

100 g of the pancake mix composition and 170 cc of cool water were put into a kneading trough and were softly stirred them with eggbeater to make pancake paste. To the paste, kimchi, leek, green onion, pumpkin etc. which were prepared by chopping with moderate size, were added and uniformly mixed them together. Then, edible oil was applied onto heated frypan and the paste was poured and spreaded onto the frypan, and then heated for 3 to 4 minutes to complete pancake.

In order to determine satisfaction for the pancake mix composition containing rice flour, the examination was performed for four hundreds wives of 29 to 40 years old living in Seoul and the result was shown in Table 5.

TABLE 5
The result of sensory test for a consumer

| | General | General | Characteristic | Necessity |
|---|---|---|---|---|
| | taste | satisfaction | evaluation | evaluation |
| Pancake mix | 3.64 | 3.56 | 3.02 | 3.57 |
| composition | | | | |
| containing wheat | | | | |
| flour | | | | |
| Pancake mix | 4.09 | 3.90 | 3.82 | 3.80 |
| composition | | | | |
| containing rice | | | | |
| flour | | | | |

* 5 point evaluation

As shown in Table 5, the pancake mix composition containing rice flour was high value on the whole aspect compared to pancake mix composition containing wheat flour, especially shown a good preference in tasty, plain and chewy taste.

As a result of the above, it can be concluded that the pancake mix composition containing rice flour can fulfill consumer's desire and newly produce a rice consumption market.

### INDUSTRIAL APPLICABILITY

The present invention relates to the pancake mix composition containing rice flour, which is useful to rice producer and food industry because it can possible to make feel comfortable with pancake to a consumer who suffers from indigestion and absorption impediment of food made from wheat flour and also to promote rice consumption by the production of high value-added products.

1. A method for preparing rice flour comprising the steps of
wet grinding rice with zet mill;
vacuum drying the grinded rice; and
separating the vacuum dried rice flour with mesh to obtain rice flour passing out 100 mesh.

2. A composition for pancake comprising 75 to 85 wt % of rice flour passing out 100 mesh according to claims 1, 5 to 15 wt % of tapioca starch and 5 to 15 wt % of additive.

3. The composition for pancake according to claim 2, in which the additive is one or combination of two or more selected from the group consisting of mixed vegetable powder, whole egg powder, corn powder, salt, sugar, Baking powder, guar gum or gardenia yellow coloring matter.
